(19) United States
(12) Patent Application Publication
(10) Pub. No.: US 2016/0342318 A1
(43) Pub. Date: Nov. 24, 2016

(54) PLATFORM FOR DEVELOPING IMMERSIVE REALITY-VIRTUALITY CONTINUUM-BASED ENVIRONMENT AND METHODS THEREOF

(71) Applicant: WAKINGGAPP LTD, Rosh Haayin, (IL)

(72) Inventors: Alon MELCHNER, ROSH HAAYIN (IL); Adiel GUR, ROSH HAAYIN (IL)

(73) Assignee: WAKINGAPP LTD., ROSH HAAYIN (IL)

(21) Appl. No.: 15/034,259

(22) PCT Filed: Nov. 16, 2015
(86) PCT No.: PCT/IL2015/051100

§ 371 Date: May 4, 2016

Related U.S. Application Data
(60) Provisional application No. 62/083,973, filed on Nov. 25, 2014.

(51) Int. Cl. G06F 3/0484; G06F 9/44; G06F 3/0486; G06F 17/30; G06T 19/00; G06F 3/0482

(52) U.S. Cl. CPC G06F 3/04847; G06T 19/006; G06F 3/0482; G06F 3/0486; G06F 17/30424; G06F 8/34

(57) ABSTRACT

The present invention provides a method for developing immersive reality-virtuality continuum-based environment, the method implemented on a platform for developing immersive reality-virtuality continuum-based environment having a display facilitator and an input device, the input device controllable by a user to create and configure visual representations on said display facilitator.

### FIELD OF THE INVENTION

The present disclosure relates to user profiling, recognition, and authentication. In particular, it relates to user profiling, recognition, and authentication in augmented and virtual realities using computer-based capturing methods, systems and devices.

### BACKGROUND OF THE INVENTION

Virtual, augmented or mixed reality environments are generated by computers using, in part, data that describes the environment. This data may describe, for example, various objects with which a user may sense and interact with. Examples of these objects include objects that are rendered and displayed for a user to see, audio that is played for a user to hear, and tactile (or haptic) feedback for a user to feel. Users may sense and interact with the virtual and augmented reality environments through a variety of visual, auditory and tactical means. Virtual, augmented or mixed realities generally refer to altering a view of reality. Artificial information about a real environment can be overlaid over a view of the real environment. The artificial information can be interactive or otherwise manipulable, providing the user of such information with an altered, and often enhanced, perception of reality. However, reality-virtuality continuum-based environment is still a relatively new area of interest with limited present-day applications.

Historically, the development of any software applications required trained and experienced software programmers to design data structures and write program code. This meant that extensive knowledge of the complexities of one or more programming languages was usually required. In recent years, however, with the introduction of windows-based operating systems and the move toward visual based user interfaces, significant progress has been made in developing visual programming tools which have made the task of designing and building applications much easier and more accessible to a wider range of people. Visual logic programming focuses on the visual user interface. With visual programming tools, the user is provided with a palette of visual objects that represent commonly required functionality. The user develops an application simply by creating objects on the screen and by moving those around using clickable and drag-and-drop techniques. The visual logic programming tool takes care of writing or adding the underlying code that is required to implement the functionality of the various objects that have been added to the screen. Thus, the process of writing large segments of code is taken over by the visual logic programming tool.

Nevertheless, even with prior visual programming tools, in developing reality-virtuality continuum-based environments users have still had to write and add code to the application under design to complete it. Thus, even though coding tools have made in general the process of designing and building applications much easier, they still have left standing significant barriers to users who are not experienced in programming or writing code for reality-virtuality continuum-based environment. Augmented or mixed reality is a way of superimposing or overlaying computer generated information onto a physical or real-world environment. Augmented reality (AR) provides a view of a physical, real-world environment whose elements are augmented (or supplemented) by computer-generated sensory input such as sound, text, graphics, or video. Augmented reality is useful in various applications including construction, repair, maintenance, education, navigation, design, military, medical, or entertainment, for example. Virtual reality (VR) provides an immersive, interactive three-dimensional computer-generated environment in which interaction takes place over multiple sensory channels and includes tactile and positioning feedback. A review of existing programming immersive reality-virtuality continuum-based environment platforms reveals a need for an improved software development system and method which incorporates object-oriented design, serialization and a visual platform to develop immersive reality-virtuality continuum-based environment for users to use clickable and drag-and-drop techniques with no coding skills required.

In light of the above, there is a long term unmet need to provide such platform for developing immersive reality-virtuality continuum-based environment by using clickable and drag-and-drop techniques.

### SUMMARY OF THE INVENTION

It is hence one object of this invention to disclose a platform for developing immersive reality-virtuality continuum-based environment by using clickable and drag-and-drop techniques. In general, in one aspect the invention is a visual programming developing immersive reality-virtuality continuum-based environment tool and method that includes a digital molecule, which is represented by a visual screen representation thereof. Associated with the digital molecule is an external file(s) containing dynamic/changeable/growing predefined events, i.e., command scripts which define settings that will be performed by the digital molecule on a reality-virtuality continuum-based destination object to which it is connected. The external file(s) contains behaviors for many different combinations of object types that are possible with the visual programming tool. When the user connects a digital molecule to a reality-virtuality continuum-based destination object, the programming tool presents the user with a list of the predefined events from the external file that are appropriate for that particular combination of digital molecule and a reality-virtuality continuum-based destination object.

In general, another object of this invention is to disclose a visual programming developing immersive reality-virtuality continuum-based environment tool and method that includes a digital atoms, which is represented by a visual screen representation thereof. By selecting several types of digital atoms and creating bonds between them by connecting their digital electrons, a digital molecule is created which then represents a certain, custom-made behavior that the app runtime-engine is able to execute when the event in the digital molecule is activated. The logic molecule(s) can then be serialized and saved per scene per project. The app is able then to deserialize and execute the various logic molecules that were serialized as a logic molecule map.

Another object of this invention is to disclose a visual programming method that is implemented on a computer having a display facilitator and an input device which a user employs to manipulate visual representations on the display facilitator. The method comprises the steps of A method for developing immersive reality-virtuality continuum-based environment, the method implemented on a platform for developing immersive reality-virtuality continuum-based environment having a display facilitator and an input device, the input device controllable by a user to create and configure visual representations on said display facilitator, said method comprising steps of creating, developing and configuring one or more of digital atoms, said digital atoms including a linking to a reality-virtuality continuum-based destination object; selecting, in response to input from said user, one or more of said digital atoms; generating, in response to input from said user, one or more visual representations on said display facilitator, said reality-virtuality continuum-based destination object, said reality-virtuality continuum-based destination object being an instance of said digital atoms having one or more associated default events and property settings; creating and configuring one or more of digital molecule, said digital molecule comprises one or more said digital atom; selecting, in response to input from said user, one or more said digital molecules; generating, in response to input from said user, one or more visual representation on said display facilitator, one or more said linking digital atoms, said digital atoms being an instance of said digital atoms and having one or more of user selectable predefined behaviors used by said reality-virtuality continuum-based destination object, said predefined behaviors being responsive to at least one of said associated events; creating and configuring one or more of digital electrons, said digital electrons including a linking to one or more said digital atoms; selecting, in response to input from said user, one or more said digital electrons; generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events; and displaying, in response to input from the user, said default events and property settings, of selected of said reality-virtuality continuum-based destination object.

Preferred embodiments include providing a separate database of predefined events for various bonded combinations of said digital atoms. The step of retrieving one or more of user selectable predefined behaviors from said database; and selecting one or more of user selectable predefined behaviors as a default behavior for said digital atoms. Preferred embodiments include providing a separate database of predefined behaviors for various bonded combinations of said digital atoms. The step of retrieving one or more of user selectable predefined behaviors from said database; and selecting one or more of user selectable predefined behaviors as a default behavior for said digital atoms. Preferred embodiments include providing a separate database of predefined behaviors for various bonded combinations of said digital electrons. The step of retrieving one or more of user selectable predefined arguments from said database; and selecting one or more of user selectable predefined arguments as a default behavior for said digital electrons.

Another object of this invention is to disclose a dynamic and user-friendly graphical interface that enables users to easily develop reality-virtuality continuum-based environment. The visual linking system of molecular-like space enables users to join various pieces of code together simply by adding to and manipulating graphical objects within a designer window. The invention shields the application developer from having to write any code or from having to learn the complexities of programming to build reality-virtuality continuum-based environment. The platform development tools of the invention are very easy to use. The predefined behaviors that are provided with the linking atoms anticipate the functionality that users will want to use in building reality-virtuality continuum-based environment for accessing, manipulating and displaying data and information.

It is hence another object of this invention to bring the ability of processing configuration files that specify the correct commands and parameters inside a closed app enable the freedom and complexity of scripting with no boundaries that the AR/VR platform enables and introduce a flexible, different and dynamic behaviors in one vessel app the can activate different types of result and logic and therefore to offer different applications in one “official app player” that runs them all.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 presents a logic module map section according to the present invention;

FIG. 2 presents a player-engine section according to the present invention;

FIG. 3 is a flow diagram illustrating a method for developing immersive reality-virtuality continuum-based environment by using clickable and drag-and-drop techniques;

FIG. 4 presents schematically presents a digital atom and a digital electron according to the present invention in use.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The term “reality-virtuality continuum-based environment” refers in the present invention to augmented and/or virtual reality and/or any other “mixed reality” content (combination of real world and digital world including AR, VR, holograms, projections, smart glasses, 2D & 3D mixed reality, dynamic data and any other digital content that may appear inside mixed reality).

The term “molecule” refers in the present invention to one or more groups of premade logic commands (atoms) that offer mid-high level visual scripting that when combined together and connected to the 2D & 3D objects in the AR/VR environment enables a dynamic and interactive ability like AI, data connectivity, detections, placements, and more. A logic molecule map contains collections of atoms and bonds, every scene has its own collection of logic molecule maps that the user can control (create/update/delete new molecules & atoms).

The term “atom” refers in the present invention to one or more commands or one or more events, when placed on the map it is serialized as lines in a configuration file that is recorded on a cloud and when being processed at the runtime by an app, the configuration is de-serialized to the right commands inside the app.

The term “electrons” refers in the present invention to low level arguments that can be a set of extra parameters that define the atom and appear around it. The user can manipulate them by rotating them around the atom so the molecule map and flow will be easier to understand. Low level arguments include: number—used for any type of number either to be it a floating value parameter or an integer. To avoid errors within logic, conversions should take place in the player-engine section when an incorrect format is given (i.e: when a value of 1.4 f is handed over to a function that accepts an array's index value, the digits after the ‘.’ should be removed handing over 1 i instead of 1.4 f as a result). Number arguments can also be referenced to numbers variables; text —used for any type of string or single character value, the equivalent of C#'s string type. Text arguments can also be referenced to texts variables; flag—can be either TRUE or FALSE. Flag arguments can also be referenced to flags variables; execute −/+—used for logic “flow”, a “+” can only be bonded to one single “−”, while a “−” can be bonded to multiple “+” sockets, i.e. [Inline images 1]. Event atoms only have a “+” argument. Action atoms have “+” and “−” arguments for when they are triggered and what do they trigger next. Object atoms don't have any execution argument; object value(get)—used as the “return value” aka constructed object by an object type atom. Every object based atom has an x-amount of arguments (i.e: vector object has 3 arguments-x,y,z.). Yet every object based atom has only 1 exposed argument “Get” which results in the constructed vector being passed to the connected atom; Object Reference(Set)—used as a reference to a “returned value” in order to connect an object based atom (through the “Get” argument) to an action, event or another object based atom (i.e: the “Get Distance Between 2 Objects” Action atom takes in 2 Vector parameters OR Object parameters and sets a Number value “result” with the distance between them). “result” is then used like a “Get” for other “Object Reference” arguments within atoms to connect to.

The term “bond” refers in the present invention to a line that connects two arguments, a “GET” and a “SET” type parameters (i.e: “+” and “−” which are equivalent to “set next action to execute {type action expected}” and “get this action {action type returned}” accordingly; “parameter 1 {type flag expected}” to “<some name> flag atom get argument {flag type returned}”).

The term “digital direction arrow” refers in the present invention to a direction of any GET into SET argument between one or more bonds, hence it is used for digital electrons connections (i.g. shows the direction of a GET->SET action).

The term “player-engine section” refers in the present invention to programming platform where a user can inspect and interact with reality-virtuality continuum-based destination object in real-time.

The term “logic molecule map/logic-engine section” refers in the present invention to programming platform where a user can use clickable and drag-and-drop actions to define and manipulate a reality-virtuality continuum-based destination object.

The term “developing”, as used in the present invention, refers to creating, designing, establishing, modifying, or adapting reality-virtuality continuum-based destination object to form a specific configuration or for some specific purpose, for example in a form of collective reality-virtuality continuum-based environment.

The term “display facilitator”, as used in the present invention, refers to display surface that can facilitate any visual representation of the reality-virtuality continuum-based environment, e.g. computer screen, hologram, 3D environment and more.

The term “user” refers to a person attempting to develop immersive reality-virtuality continuum-based environment by using clickable and drag-and-drop techniques.

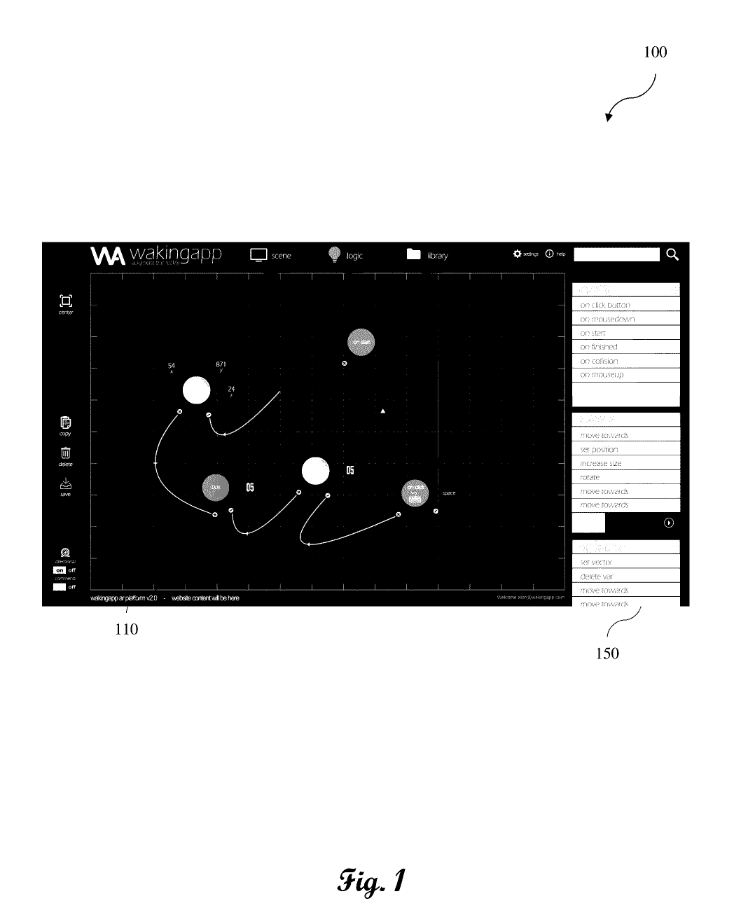

Reference is made to FIG. 1, presenting a platform [100] presentation of the basic method for developing immersive reality-virtuality continuum-based environment by using clickable and drag-and-drop techniques having a display facilitator and an input device, the input device controllable by a user to create and configure visual representations on said display facilitator, said platform comprising logic molecule map [110], said logic molecule map is used for creating, developing and configuring one or more of digital atoms [130], said digital atoms including a linking to a reality-virtuality continuum-based destination object; selecting, in response to input from said user, one or more of said digital atoms [120]; generating, in response to input from said user, one or more visual representations on said display facilitator, said reality-virtuality continuum-based destination object, said reality-virtuality continuum-based destination object being an instance of said digital atoms [130] having one or more associated default events and property settings [150]; creating and configuring one or more of digital molecules [120], said digital molecule comprises one or more said digital atom; selecting, in response to input from said user, one or more said digital molecules; generating, in response to input from said user, one or more visual representation on said display facilitator, one or more said linking digital atoms, said digital atoms being an instance of said digital atoms and having one or more of user selectable predefined behaviors [150] used by said reality-virtuality continuum-based destination object, said predefined behaviors being responsive to at least one of said associated events; creating and configuring one or more of digital electrons [140], said digital electrons including a linking to one or more said digital atoms; selecting, in response to input from said user, one or more said digital electrons; generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events; creating and configuring one or more of digital direction arrows, said digital direction arrows including a linking to one or more said digital electrons; selecting, in response to input from said user, one or more said digital direction arrows; generating, in response to input from said user, one or more visual representation on said display facilitator, one or more said linking digital direction arrows, said digital direction arrows being an instance of said digital electrons and connecting one or more of arguments used by said reality-virtuality continuum-based destination object, said arguments being responsive to at least one of said associated events; and displaying, in response to input from the user, said default events and property settings, of selected of said reality-virtuality continuum-based destination object. Based on its class, each atom in the platform can respond to a predefined set of events. Events initiate the execution of application procedures. Many events are user actions, such as clicking a command button or a check box (Click events). Other events are internal, such as the elapsing of a specified interval for a timer object (a Timer event) or the completion of a database operation initiated by a data object (an Execute event). Some events are notification that something is about to happen. Events may also be triggered programmatically.

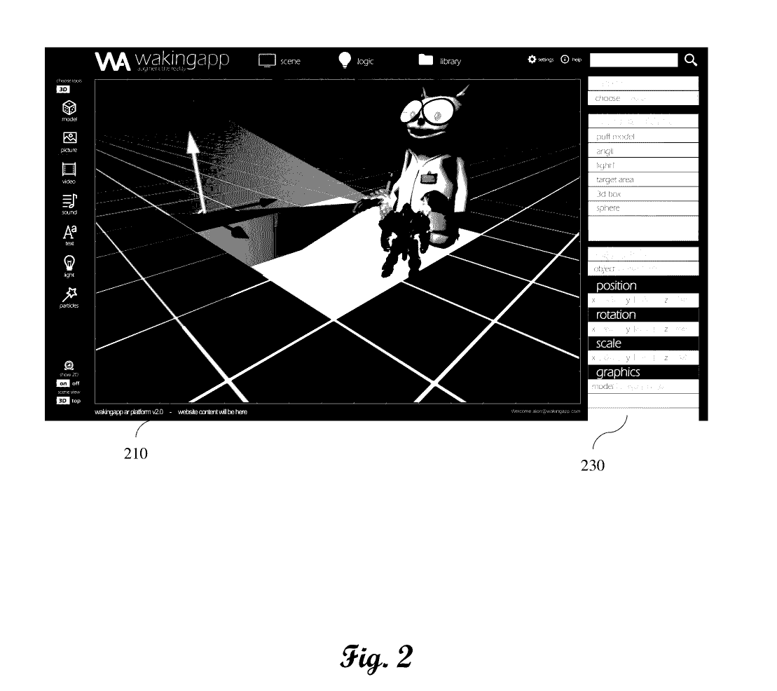

Reference is made to FIG. 2, presenting a platform [200] presentation of the basic method for developing immersive reality-virtuality continuum-based environment by using clickable and drag-and-drop techniques having a display facilitator and an input device, the input device controllable by a user to create and configure visual representations on said display facilitator, said platform comprising player-engine section [210], said player-engine section is used for creating, developing and configuring a reality-virtuality continuum-based destination object [220] through one or more of digital atoms, said digital atoms including a linking to said reality-virtuality continuum-based destination object, said reality-virtuality continuum-based destination object being an instance of said digital atoms having one or more associated default events and property settings [230].

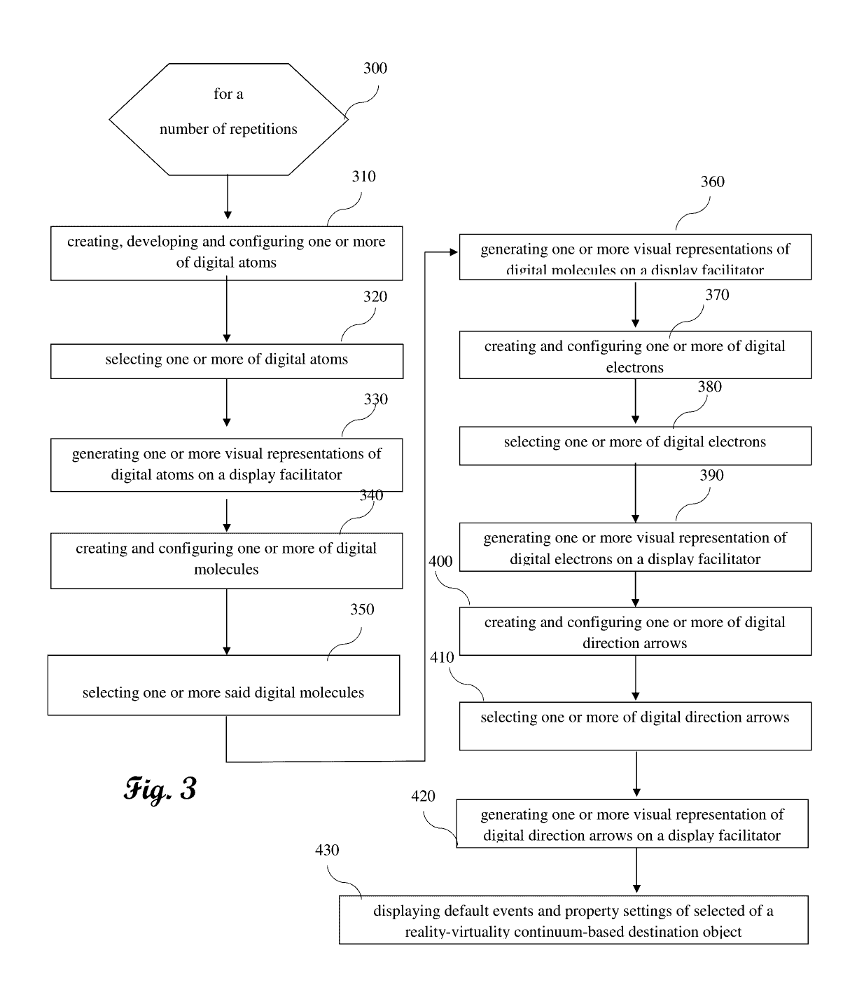

Reference is now made to FIG. 3, presenting a flow diagram illustrating a method for developing immersive reality-virtuality continuum-based environment. Said method comprises, for a predetermined number of repetitions [300], steps of creating, developing and configuring one or more of digital atoms, said digital atoms including a linking to a reality-virtuality continuum-based destination object [310]; selecting, in response to input from said user, one or more of said digital atoms [320]; generating, in response to input from said user, one or more visual representations on said display facilitator, said reality-virtuality continuum-based destination object, said reality-virtuality continuum-based destination object being an instance of said digital atoms having one or more associated default events and property settings [330]; creating and configuring one or more of digital molecule, said digital molecule comprises one or more said digital atom [340]; selecting, in response to input from said user, one or more said digital molecules [350]; generating, in response to input from said user, one or more visual representation on said display facilitator, one or more said linking digital atoms, said digital atoms being an instance of said digital atoms and having one or more of user selectable predefined behaviors used by said reality-virtuality continuum-based destination object, said predefined behaviors being responsive to at least one of said associated events [360]; creating and configuring one or more of digital electrons, said digital electrons including a linking to one or more said digital atoms [370]; selecting, in response to input from said user, one or more said digital electrons [380]; generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events [390]; creating and configuring one or more of digital direction arrows, said digital direction arrows including a linking to one or more said digital electrons [400]; selecting, in response to input from said user, one or more said digital direction arrows [410]; generating, in response to input from said user, one or more visual representation on said display facilitator, one or more said linking digital direction arrows, said digital direction arrows being an instance of said digital electrons and connecting one or more of arguments used by said reality-virtuality continuum-based destination object, said arguments being responsive to at least one of said associated events [420]; and displaying, in response to input from the user, said default events and property settings, of selected of said reality-virtuality continuum-based destination object [430].

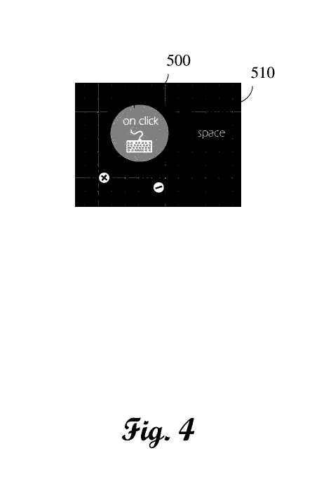

Reference is now made to FIG. 4, presenting a digital atom [500] including a linking to a reality-virtuality continuum-based destination object and a digital electron [510] including a linking to one or more said digital atoms. Digital atoms can comprise different groups of atoms, having different function based on predefined functionality such as “event atoms” which are “gateways” into a “flow structure”, they only have a “+” for executing an action atom and some of them have other arguments as well. Event atoms don't have a “−” execution argument as nothing can trigger them but the logic-engine section; action atoms which have both a “+” argument and a “−” argument for when they are triggered and what do they trigger afterwards if they do. Action atoms can “save” arguments of “GET” type. Structure atoms which are object atoms having GET {the object as reference}, SET {a reference to an object} and public GET type low-level arguments (i.e: a vector atom would contain GET {Vector}, SET {Vector Expected}, X {Number}, Y {Number}, Z {Number}; scene referenced atoms—which only have GET {the object as reference} argument and are created by dragging scene objects into the logic editor.

1-25. (canceled)

26. A method for developing immersive reality-virtuality continuum-based environment, the method implemented on a platform for developing immersive reality-virtuality continuum-based environment having a display facilitator and an input device, the input device controllable by a user to create and configure visual representations on said display facilitator, said method comprising steps of:
a. creating, developing and configuring one or more of digital atoms, said digital atoms including a linking to a reality-virtuality continuum-based destination object;
b. selecting, in response to input from said user, one or more of said digital atoms;
c. generating, in response to input from said user, one or more visual representations on said display facilitator, said reality-virtuality continuum-based destination object, said reality-virtuality continuum-based destination object being an instance of said digital atoms having one or more associated default events and property settings;
d. creating and configuring one or more of digital molecule, said digital molecule comprises one or more said digital atom;
e. selecting, in response to input from said user, one or more said digital molecules;
f. generating, in response to input from said user, one or more visual representation on said display facilitator, one or more said linking digital atoms, said digital atoms being an instance of said digital atoms and having one or more of user selectable predefined behaviors used by said reality-virtuality continuum-based destination object, said predefined behaviors being responsive to at least one of said associated events;
g. creating and configuring one or more of digital electrons, said digital electrons including a linking to one or more said digital atoms;
h. selecting, in response to input from said user, one or more said digital electrons;
i. generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events;
j. creating and configuring one or more of digital direction arrows, said digital direction arrows including a linking to one or more said digital electrons;
k. selecting, in response to input from said user, one or more said digital direction arrows;
l. generating, in response to input from said user, one or more visual representation on said display facilitator, one or more said linking digital direction arrows, said digital direction arrows being an instance of said digital electrons and connecting one or more of arguments used by said reality-virtuality continuum-based destination object, said arguments being responsive to at least one of said associated events; and
m. displaying, in response to input from the user, said default events and property settings, of selected of said reality-virtuality continuum-based destination object.

27. The method of claim 26 further comprising the step of:
a. providing a separate database of dynamic/predefined events for various bonded combinations of said digital atoms;
wherein step c comprises:
i. retrieving one or more of user selectable predefined behaviors from said database; and
ii. selecting one or more of user selectable predefined behaviors as a default behavior for said digital atoms;
b. providing a separate database of predefined behaviors for various bonded combinations of said digital atoms;
wherein step f comprises:
i. retrieving one or more of user selectable predefined behaviors from said database; and
ii. selecting one or more of user selectable predefined behaviors as a default behavior for said digital atoms;
c. providing a separate database of predefined arguments for various bonded combinations of said digital electrons;
wherein step i comprises:
i. retrieving one or more of user selectable predefined arguments from said database; and
ii. selecting one or more of user selectable predefined arguments as a default behavior for said digital electrons.

28. The method of claim 26 wherein each of the behaviors are scripts defining actions involving said reality-virtuality continuum-based destination object in response to an occurrence of one or more of said events.

29. The method of claim 26 wherein a dynamic code and logic are activated to offer new results for every reality-virtuality continuum-based destination object created.

30. The method of claim 26 wherein a dynamic code and logic are activated to offer a user a real-time presentation of flow-order of the executed script involving said reality-virtuality continuum-based destination object.

31. The method of claim 28 wherein the computer system includes an operating system, wherein one or more of said events is caused by said operating system.

32. The method of claim 28 wherein the computer system includes a cloud-based platform for developing immersive reality-virtuality continuum-based environment platform, wherein one or more of said events is caused by said cloud-based platform.

33. The method of claim 28 wherein the computer system includes a web-based platform for developing immersive reality-virtuality continuum-based environment platform, wherein one or more of said events is caused by said web-based platform.

34. The method of claim 28 wherein one of the events is caused by interaction with said user via said input device.

35. The method of claim 28 wherein one or more of said events is triggered programmatically.

36. The method of claim 28 wherein step f comprises the steps of:
a. displaying a clickable and drag-and-drop interface comprising said digital molecules linking said digital atoms linking said electrons;
b. editing one or more said digital atoms linking said digital atoms, said digital atoms defining one or more relationships with said reality-virtuality continuum-based destination object; and
c. associating one or more relationships with said reality-virtuality continuum-based destination object.

37. The method as defined by claim 26 further including the step of:
a. providing a palette of visual digital atoms;
b. utilizing the palette of visual digital atoms for selecting one or more of said digital atoms.

38. The method as defined by claim 26 further including the step of:
a. providing a palette of visual digital electrons;
b. utilizing the palette of visual digital atoms for selecting one or more of said digital electrons.

39. An apparatus for visually creating developing immersive reality-virtuality continuum-based environment, said apparatus implemented on a computer system having a display facilitator and an input device, said input device controllable by a user to create visual representations on said display facilitator, said reality-virtuality continuum-based environment programming apparatus comprising:
a. means for creating, developing and configuring one or more of digital atoms, said digital atoms including a linking to a reality-virtuality continuum-based destination object;
b. means for selecting, in response to input from said user, one or more of said digital atoms;
c. means for generating, in response to input from said user, one or more visual representations on said display facilitator, said reality-virtuality continuum-based destination object, said reality-virtuality continuum-based destination object being an instance of said digital atoms having one or more associated default events and property settings;
d. means for creating and configuring one or more of digital molecule, said digital molecule comprises one or more said digital atom;
e. means for selecting, in response to input from said user, one or more said digital molecules;
f. means for generating, in response to input from said user, one or more visual representation on said display facilitator, one or more said linking digital atoms, said digital atoms being an instance of said digital atoms and having one or more of user selectable predefined behaviors used by said reality-virtuality continuum-based destination object, said predefined behaviors being responsive to at least one of said associated events;
g. means for creating and configuring one or more of digital electrons, said digital electrons including a linking to one or more said digital atoms;
h. means for selecting, in response to input from said user, one or more said digital electrons;
i. means for generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events;
j. means for creating and configuring one or more of digital direction arrows, said digital direction arrows including a linking to one or more said digital electrons;
k. means for selecting, in response to input from said user, one or more said digital direction arrows;
l. means for generating, in response to input from said user, one or more visual representation on said display facilitator, one or more said linking digital direction arrows, said digital direction arrows being an instance of said digital electrons and connecting one or more of arguments used by said reality-virtuality continuum-based destination object, said arguments being responsive to at least one of said associated events; and
m. means for displaying, in response to input from the user, said default events and property settings, of selected of said reality-virtuality continuum-based destination object.

40. A platform for developing immersive reality-virtuality continuum-based environment for use with a computer system having a display facilitator and an input device, said platform for developing immersive reality-virtuality continuum-based environment comprising:
a. a computer usable medium having computer readable program code thereon for visually programming an application program, the computer readable program code comprising:
i. program code for creating, developing and configuring one or more of digital atoms, said digital atoms including a linking to a reality-virtuality continuum-based destination object;
ii. program code for selecting, in response to input from said user, one or more of said digital atoms;
iii. program code for generating, in response to input from said user, one or more visual representations on said display facilitator, said reality-virtuality continuum-based destination object, said reality-virtuality continuum-based destination object being an instance of said digital atoms having one or more associated default events and property settings;
iv. program code for creating and configuring one or more of digital molecule, said digital molecule comprises one or more said digital atom;
v. program code for selecting, in response to input from said user, one or more said digital molecules;
vi. program code for generating, in response to input from said user, one or more visual representation on said display facilitator, one or more said linking digital atoms, said digital atoms being an instance of said digital atoms and having one or more of user selectable predefined behaviors used by said reality-virtuality continuum-based destination object, said predefined behaviors being responsive to at least one of said associated events;
vii. program code for creating and configuring one or more of digital electrons, said digital electrons including a linking to one or more said digital atoms;
viii. program code for selecting, in response to input from said user, one or more said digital electrons;
ix. program code for generating, in response to input from said user, one or more visual representation on said display facilitator, one or more said linking digital electrons, said digital electrons being an instance of said digital atoms and connecting one or more of arguments used by said reality-virtuality continuum-based destination object, said arguments being responsive to at least one of said associated events;
x. program code for creating and configuring one or more of digital direction arrows, said digital direction arrows including a linking to one or more said digital electrons;
xi. program code for selecting, in response to input from said user, one or more said digital direction arrows;
xii. program code for generating, in response to input from said user, one or more visual representation on said display facilitator, one or more said linking digital direction arrows, said digital direction arrows being an instance of said digital electrons and connecting one or more of arguments used by said reality-virtuality continuum-based destination object, said arguments being responsive to at least one of said associated events; and
xiii. program code for displaying, in response to input from the user, said default events and property settings, of selected of said reality-virtuality continuum-based destination object.

41. The platform for developing immersive reality-virtuality continuum-based environment of claim 40 further comprising:
a. program code for providing a separate database of predefined events for various bonded combinations of said digital atoms;
wherein the means for generating said digital atoms comprise:
i. program code for retrieving one or more of user selectable predefined behaviors from said database; and
ii. program code for selecting one or more of user selectable predefined behaviors as a default behavior for said digital atoms;
b. a program code for proving a separate database of predefined behaviors for various bonded combinations of said digital atoms;
wherein the means for generating said digital atoms comprise:
i. program code for retrieving one or more of user selectable predefined behaviors from said database; and
ii. program code for selecting one or more of user selectable predefined behaviors as a default behavior for said digital atoms;
c. program code for providing a separate database of predefined arguments for various bonded combinations of said digital electrons;
wherein the means for generating said digital electrons comprise:
i. program code for retrieving one or more of user selectable predefined arguments from said database; and
ii. program code for selecting one or more of user selectable predefined arguments as a default behavior for said digital electrons.

42. The platform for developing immersive reality-virtuality continuum-based environment of claim 40 wherein the program code for developing immersive reality-virtuality continuum-based environment further comprises the steps of:
a. program code for displaying a clickable and drag-and-drop interface comprising said digital molecules linking said digital atoms linking said digital electrons;
b. program code for editing one or more said digital atoms linking said digital atoms, said digital atoms defining one or more relationships with said reality-virtuality continuum-based destination object; and
c. program code for associating one or more relationships with said reality-virtuality continuum-based destination object.

43. The platform for developing immersive reality-virtuality continuum-based environment of claim 40 wherein the program code for developing immersive reality-virtuality continuum-based environment further comprises the steps of:
a. program code for a clickable and drag-and-drop interface comprising said digital atoms linking said digital atoms linking said digital electrons;
b. program code for editing one or more said digital atoms linking said digital atoms, said digital atoms defining one or more relationships with said reality-virtuality continuum-based destination object; and
c. program code for associating one or more relationships with said reality-virtuality continuum-based destination object.

44. The platform for developing immersive reality-virtuality continuum-based environment of claim 40 wherein the program code for developing immersive reality-virtuality continuum-based environment further comprises the steps of:
a. program code for a palette of visual digital atoms;
b. program code for utilizing the palette of visual digital atoms for selecting one or more of said digital atoms.

45. The platform for developing immersive reality-virtuality continuum-based environment of claim 40 wherein the program code for developing immersive reality-virtuality continuum-based environment further comprises the steps of:
a. program code for a palette of visual digital electrons;
b. program code for utilizing the palette of visual digital electrons for selecting one or more of said digital electrons.
